(19) United States
(12) Patent Application Publication
(10) Pub. No.: US 2008/0281730 A1
(43) Pub. Date: Nov. 13, 2008

(54) Method and system for digital image inventors and claims processing

(76) Inventor: Daniel Margolis, Coral Springs, FL (US)

Correspondence Address: MINTZ LEVIN COHN FERRIS GLOVSKY & POPEO;ATTN: PATENT INTAKE CUSTOMER NO. 35437, ONE FINANCIAL CENTER, BOSTON, MA, 02111, US

(21) Appl. No.: 12/148,878

(22) Filed: Apr. 22, 2008

Related U.S. Application Data
(60) Provisional application No. 60/925,823, filed on Apr. 23, 2007.

(51) Int. Cl. G06Q 10/00

(52) U.S. Cl. 705/28; 235/385

(57) ABSTRACT

An electronic system for inventorying shipments of items and processing claims for damages to those items. Furthermore, the system also generates digital image inventories of shipments and processes claims for damages.

### RELATED APPLICATIONS

This application claims priority to, and the benefit of, U.S. Provisional Application No. 60/925,823, filed Apr. 23, 2007, the contents of which are incorporated herein by reference in its entirety.

### FIELD

The subject matter enclosed herein relates generally to methods and apparatus for inventorying shipments of items (e.g., boxes, furniture and other items) and processing claims for damages to those items and, more particularly, to methods and systems for generating digital image inventories of shipments and processing claims for damages.

### BACKGROUND

In the moving (shipping) industry, moves are typically grouped into 3 categories, all dealing with where they start from (origin), and where they are being delivered to (destination). Those categories are:

1. Interstate—shipments whose origin and destination addresses result in the transportation crossing state lines;

2. Intrastate—shipments whose origin and destination addresses are within the same state, but are usually greater than 50 miles apart; and

3. Local—shipments whose origin and destination addresses are within a 50 mile radius.

The differentiation between these three categories is critical, because laws, licenses, and jurisdiction are different for each. Origin and destination govern which governmental body has authority, when it comes to residential moves. Commercial moves (moving of offices and companies) typically do not have any such protection, so they do not apply. As a sub-grouping of these categories, certain shipments that come into storage can arise out of any of the three categories:

1. Interstate—bound by the US DOT, FMCSA, and federal laws and statutes;

2. Intrastate—bound by the state (e.g., Florida), and the rules it has passed; and

3. Local—typically bound by the locality (e.g., county) in which business is conducted, but the state may or may not have jurisdiction as well.

Traditional approaches for taking inventories have been provided in the moving industry, for the purpose of recording the items that a mover picks up, and the condition of each piece prior to handling by the mover—so as to establish liability. The inventory process according to these approaches proceeds as follows: every item that a mover loads is tagged with a numbered inventory sticker, and that sticker number is recorded on an inventory sheet, along with a description of pre-existing conditions, utilizing a pre-set code, listed at the top of each page. This inventory process is the same regardless of the shipment. To begin with, US DOT regulations mandate that inventories be done on ALL interstate shipments. Another time (and perhaps the only other time) that movers do a comprehensive inventory is when a shipment is inbound storage. When a shipment is loaded and unloaded in the same day (or not coming off the truck for a day or two), most if not all of the movers in the country do not do an inventory. Interstate moves are typically Less Than Truckload (LTL) shipments—most of the time more than one shipment is included on a truck at any given time, so inventory stickers are color-coded, and have lot numbers, to cut down on the chance of mixing up loads. The same holds true for the warehouse, when it comes to storage.

Such traditional approaches to taking inventories are problematic. Typically, a mover (e.g., the driver or foreman) will arrive at someone's home on the day of the move, and inventory the goods prior to loading. Often times, the mover's education level is somewhere along the lines of a GED/high school graduate. He/she will proceed to inventory each item in the house, using the letters and numbers, to describe any pre-existing damage that he/she sees. Two of the biggest problems encountered in this situation are (i) inaccurate documentation and (ii) incomplete documentation—these inventories take a good deal of time to complete, and theoretically nothing can get started with respect to moving the items into the truck until these inventories have been completed. As a result, there is pressure on the mover to get the inventory done quickly, as the customer and the crew wait around doing nothing until the mover is done. Doing inventories prior to the move date is also problematic, because if anything happens to the furniture between the time it is inventoried and loaded into the truck, the moving company could still be liable unless it spots the fresh damage the day of the move.

Another problem with traditional inventory processes is the subjectivity involved. Many claims are being handled, and ultimately settled, solely on the basis of subjectivity, with regards to the interpretation of the particular inventory sheets when it comes to perceived or actual damage of an item. The majority of the claims do not even consider the condition of the piece after it has been delivered. It usually is accepted that the customer has a damaged piece, whether the damage is actual or perceived. The focus during these processes is typically the condition of the piece prior to the mover(s) handling it, which is when the liability of the mover starts. This liability rests solely on the ability of the mover to write up a descriptive inventory, and more often than not, the inventories are vague and overly broad, as movers have come to believe that by writing up pieces as “scratched all over”, for example, they are covering themselves in the event of a claim.

When a claim is filed, typically it is handled by a claims manager (e.g., employee of the mover or insurance carrier) in an office who compares the notes of the inventory to the description of damage on a claim form. The claims manager may also compare photos of the damaged items (when they are provided by the party submitting the claim) with whatever documentation exists regarding the pre-condition(s) of the piece(s). Subsequently, the claims manager decides whether it is likely that the damages were pre-existing and/or decides on the extent of the mover's liability based on the terms and conditions of the bill of lading. While physically inspecting the damages is very helpful, it is not always practical, as moves go hundreds/thousands of miles away. Regardless, a physical inspection is done after the fact. Typically the only documentation in place for prior to the fact is the inventory sheets. Thus, most, if not all, movers handle claims internally, unless they are serious in nature (‘serious’ meaning extensive/extreme liability), at which point they are forwarded to the mover's respective insurance carrier (the same as auto insurance, where most fender-benders go unreported). Movers are leery of submitting claims to their carrier, because they feel the carrier is quick to settle. The reality is that without a clear, accurate inventory, the condition of the piece(s) prior to handling is subject to debate and therefore in many cases it is less expensive to settle.

The following description illustrates, by example, three situations that can result in claims in the moving business. Firstly, fabric sofas and chairs situated in someone's home, away from the sunlight, are often the subject of claims when they are moved to the new home and placed in direct sunlight. This is because suddenly all of the pre-existing stains are illuminated, and having never been noticed before by the customer, the customer believes that the mover is liable for the claims. While movers can try to preempt this issue by always looking for these items and pointing them out to the customer before the move, customer's often deny that they were told in advance about the pre-existing conditions. Even when the customer admits that it has been informed about some pre-existing damage, the customer typically states that the damage forming the basis for the claim was not pre-existing (e.g., “the pre-existing damage was only a rub . . . the tear happened from the move” or “that isn't the spot I'm talking about”).

Another situation that can result in a claim is when a shipment is brought into storage. Even if the driver writes up an excellent inventory report in terms of detail and thoroughness, disputes can still arise. For example, the report may state that the dining room table is chipped and gouged, left side, edge, middle. Despite this fact, when the shipment is delivered out of storage, the customer may call to say that the dining room table has a gouge in the middle of the table. According to procedure, the customer would be mailed a claim form for him to fill out the specifics of his claim (i.e., gouge in middle of table). Based on this information alone, the mover would be justified in denying the claim as being pre-existing, based on an apparent match between the claim and the pre-existing damage listed on the inventory report. However, in fact the damage may be attributable to the movers. For example, the inventory report may be referring to one side of the table, and the claim may be referring to the other side of the table. Denial of the customer's legitimate claim could upset the customer and hurt the mover's business (e.g., bad word of mouth).

Still another situation that can result in a claim is when a customer's items have a significant amount of pre-existing damage. Even though the crew may write up certain pre-existing conditions, the crew may miss one or more of them and the customer may file a claim. For example, when a repair person is sent to assess/fix the damage, the repairman may conclude that the first 22 scratches on the dresser are pre-existing but that the 23^{rd} scratch is transit-related. Thus, right or wrong, the mover may be held liable for the damage. This situation is especially problematic because it is impractical (e.g., too time consuming) for the mover to write up every single item of pre-existing damage (e.g., each scratch) before the move.

Nevertheless, the inventory process is critical, not just because it is mandated by law, but because claims are an unfortunate reality of the moving industry and it is the mover's only line of defense. A good inventory can also make the claims process (for legitimate claims) easier for customers. Industry studies show 15-20% of all moves result in a claim. Even the best movers may damage some items during transport from time to time for many different reasons, the main one being that furniture typically is not made to be shipped more than once. There are steps that can be taken to protect a piece of furniture, but the reality is that it will never be as thoroughly protected as it is the day it rolls off the factory floor ready for shipping. Thus, the inventories are necessary to protect both the customer (because not everything has pre-existing damage), as well as the mover, as pre-existing damage is at times prevalent (from other movers, kids, pets, and guests, for example).

In view of the foregoing, it would be desirable to provide new and improved methods and systems for inventorying items and processing claims for damages to those items.

### SUMMARY

Various embodiments of electronic systems for creating an inventory of shipments of items (i.e. inventorying) and processing claims for damages to those items are provided. In some embodiments, the inventory system can generate digital image inventories of shipments and processed claims for damages. Any item for shipment/moving may be used with the methods and systems described herein.

In one aspect, a method for inventorying a shipment of an item electronically and for processing claims alleging damage to the item can be provided. For example, a digital document of a surface area of the item belonging to a customer prior to handling can be generated. The document produced then can be stored on a digital camera or a video camera. The item is shipped to the destination. At the destination, the mover may generate a second digital document of the surface area of the item belonging to the customer after handling. The second document produced (e.g. the image file or the video) can also be stored. In some embodiments, a claim can be received alleging damage to the item as a result of the shipment and the claims processor may accept or deny the claim based at least in part on a comparison of the claim to the first document and/or the second document.

In some embodiments, a textual description of a condition of the item before the shipment can also be stored. In some embodiments, the document is uploaded to a computer memory. In some embodiments, the document is uploaded to a database. In some embodiments, a textual description of a condition of the item after the shipment is also stored.

In another aspect, a system for inventorying a shipment of an item electronically and for processing claims alleging damage to the item can also be provided. The system may provide a database for storing the complete surface area of at least one video or photograph of the item belonging to a customer, wherein the at least one video or photograph depicts the item prior to shipment and at least one server for receiving a claim alleging damage to the item as a result of the shipment and for publishing the claim to a web page. In some embodiments, there is a server for receiving a claim and another server for publishing the claim. In some embodiments, the system comprises at least one video or photograph that depicts the item after shipment. In some embodiments, the photograph is digital. In some embodiments, the video is digital. In some embodiments, a textual description of a condition of the item before the shipment is also stored. In some embodiments, a textual description of a condition of the item after the shipment is also stored. In some embodiments, the descriptions are electronic.

In another aspect, a software system for inventorying items and processing damage claims to items for shipment is provided. The system may provide a database adopted to store at least one digital video or photograph of said items and said claims, wherein records of customers are comprised of said at least one video or photograph; a user interface adopted to edit descriptions of said items, add at least one video or photograph of said items, and submit said claims; and an application adopted to receive said inventory and process said claims, wherein said application can connect to said database to create and access said records.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed embodiments. In the drawings:

FIGS. 1A-B show schematic diagrams of optional embodiments of the inventorying system according to the subject matter described herein.

FIG. 2 shows a flow diagram of an exemplary embodiment of the inventorying system according to the subject matter described herein.

FIG. 3A-B show schematic diagrams of exemplary embodiments of the inventorying system according to the subject matter described herein.

### DETAILED DESCRIPTION OF EMBODIMENTS OF THE PRESENT INVENTION

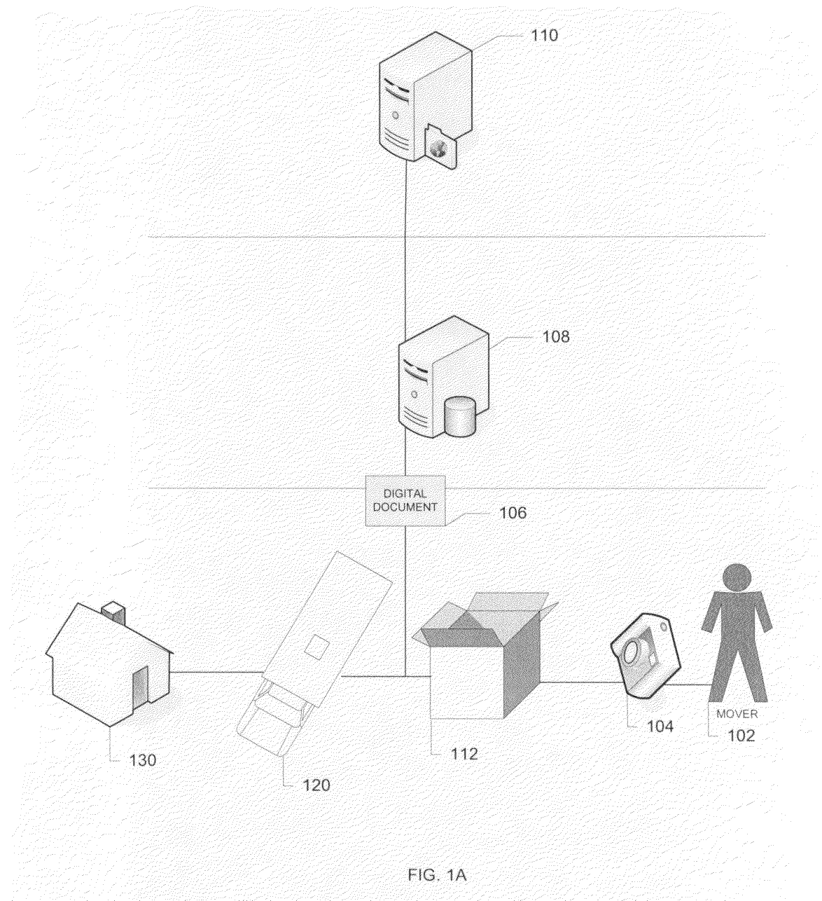

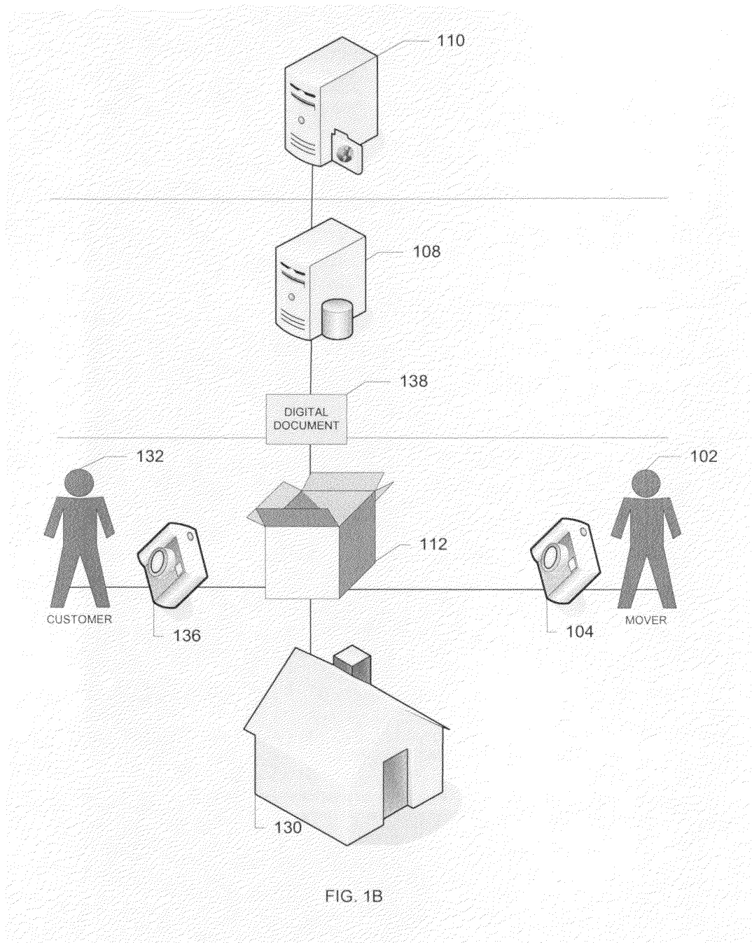

FIG. 1A-B depict schematic diagrams of the system for inventorying shipments of items and processing claims for damages to those items. In FIG. 1A, the system according to the embodiments is designed to allow a mover 102 to digitally document items 112 prior to a shipment, and before the item has been handled. In some embodiments, handling may occur when the mover first touches the items. In some embodiments, mover 102 uses a digital camera 104 to take photos of the surface area of all items 112 to be shipped in the moving company's truck 120. In some embodiments, a video camera is used to document all items. Once mover 102 has taken an inventory of all items 112 to be shipped, items 112 are loaded on to the moving company's truck 120. In some embodiments, digital documents 106 (e.g. photographs) are stored on database server 108. In some embodiments, web server 110 connects to database server 108 to retrieve the inventory of items 112. Items 112 are then shipped to the customer's destination (e.g. his new home) 130.

In FIG. 1B, items 112 have arrived at customer's 132 home 130 and are removed from moving company's truck 120. Mover 102 digitally documents items 112 after shipment and stores digital documents 138 on database server 108. In some embodiments, customer 132 notices damage to items 112. Customer 132 proceeds to create digital documentation 138 of items 112 with his camera 136 (e.g. digital camera), making sure to include views of damaged areas. In some embodiments, customer 132 then submits digital documents 138 to a claim processor at web server 110. Web server 110 and database server 108 contain data to create pages for inventory inquiries, claims submissions, and claims processing.

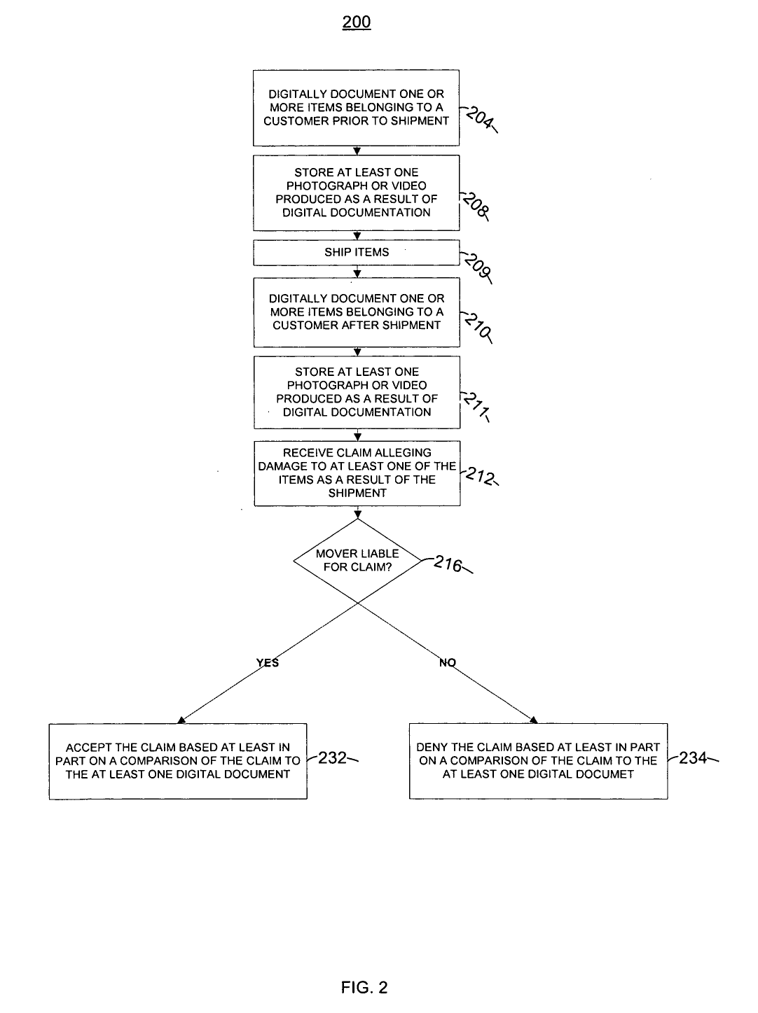

FIG. 2 depicts a flow diagram of the electronic system for inventorying shipments of items and processing claims for damages to those items. In stage 204 a mover digitally documents one or more the customer's items prior to the move. In some embodiments, the photographs are taken with a digital camera. In some embodiments, a video camera is used to digitally document the items. In stage 208 at least one of the digital documents that was taken by the mover is stored. In some embodiments, storage of the digital documentation will be on a disk of a computer or portable storage media. In some embodiments, storage of the at least one document will be in a database. Still, in some embodiments, storage of the at least one document will be on a web server. In stage 209 the items are shipped to the destination.

In stage 210 a mover digitally documents one or more the customer's items after the move. In stage 211 at least one of the documents that was taken by the mover is stored.

In stage 212 a claims processor receives a claim from the customer, alleging damage to at least one of the items as a result of the shipment. In some embodiments, the claims processor is a web site that accepts uploading of photographs or video (digital) and the like. At stage 216, if the claims processor finds the mover liable for the claim, the customer's claim is accepted at stage 232. Alternatively, if the mover is not found liable for the claim, the customer's claim is denied at stage 234.

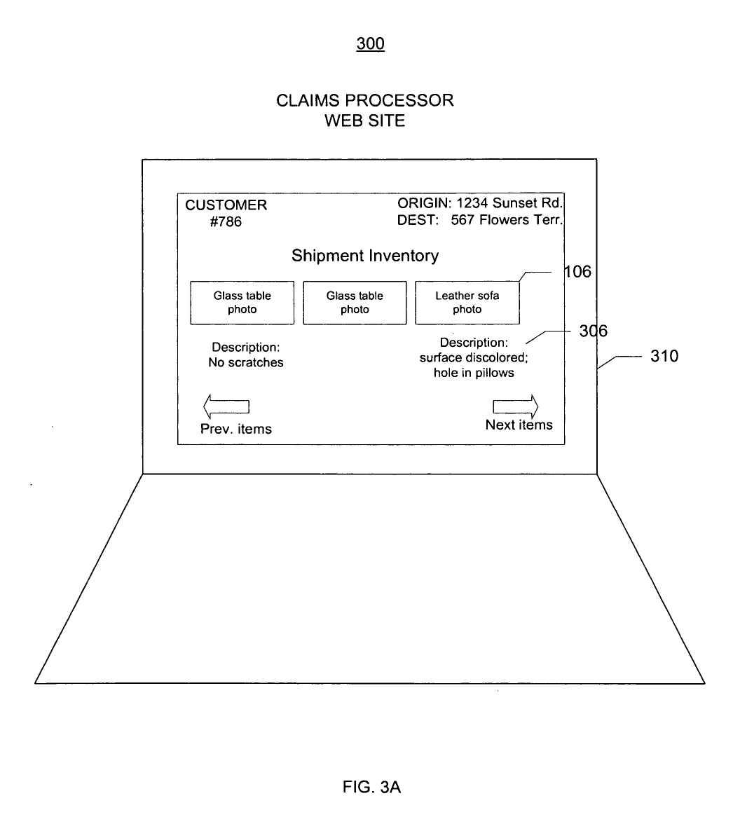

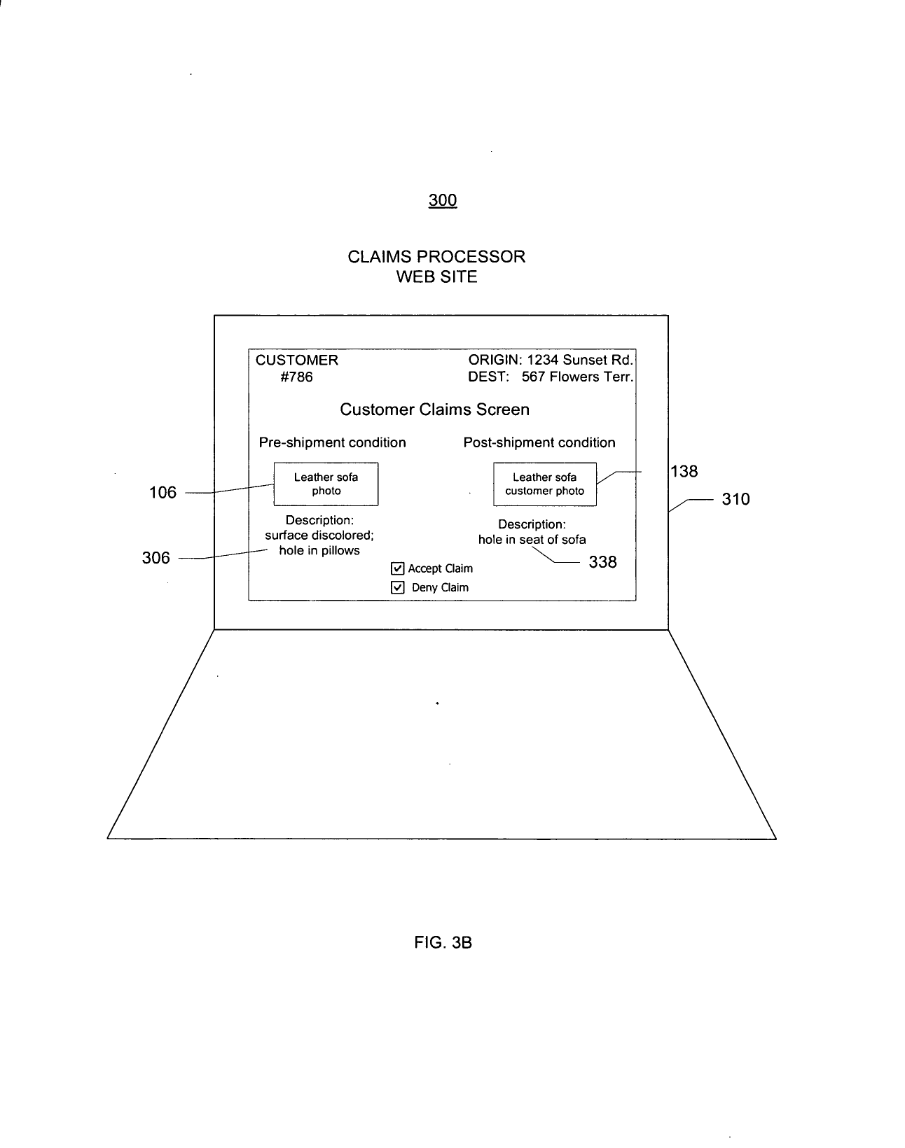

FIG. 3A-3B depict a schematic diagram of an inventorying system on a web site. In FIG. 3A, the claims processor web site user interface 310 displays a shipment inventory of items 112. The digital photograph 106 is displayed on the user interface 310, including a short description 306 of item 112. In some embodiments, a video displaying the item's complete surface and condition is available to view on the user interface 310. In FIG. 3B, the claims processor web site user interface 310 displays a customer claims screen of items 112. The digital photograph 138 of the allegedly damaged item 112 is displayed on the user interface 310, including a short description 338 of item 112, submitted by customer 132. The claims processor (e.g. a third-party) can then accept or deny the claim of customer 132.

Further embodiments of the present invention provide a comprehensive system and method for electronically recording or inventorying shipments of personal items. Embodiments also provide systems and methods for handling claims that allege damages to those items during shipping. For example, digital inventories of shipments of items may be stored in computer memory, and may be accessible (e.g., before, during, and after the move) to one or more of the customer, the moving company, and a claims processor (e.g., which may be an employee of the moving company or an employee of an insurance carrier). For example, after the move, if the customer believes that an item has been damaged in transit, the customer may access a web page that includes one or more digital images of those items. In some embodiments, the page (or other page provided by a web server) may also include textual commentary regarding the items (e.g., description of damages), which textual commentary may be provided by the moving company or customer, or both (e.g., before the move). Upon reviewing the item, the customer may be provided with an option to upload at least one digital image of the item or textual commentary, or both, regarding the condition of the item after the move, which may be submitted to and considered by a claims processor. The mover (e.g., the foreman or driver) may also be provided with an opportunity to upload commentary, for example, to rebut contentions of the customer, which textual commentary may or may not be viewable by the customer. The claims processor may make a decision whether to hold the moving company liable for the damage based at least in part on a comparison of the before and after digital documents, and the customer's submitted claim. Advantageously, some embodiments of the present invention take most, if not all, of the subjectivity out of the inventorying and claims processes.

In some embodiments, 1-3 days prior to a customer's move date, a representative may arrive at the customer's home on behalf of the moving company (e.g., an employee of the moving company or a third party) in order to digitally document all of the items that will be subject to the move in order to account for the condition of each item in addition to the number of items (e.g. 1 cabinet, 100 boxes, 1 dining table, 4 chairs). In some embodiments, multiple photos may be taken for each item (e.g., from many different angles, so as to document all of the surface area of each item). Preferably, the photos are of professional quality, taking factors such as lighting, focus, and angles into play. In some embodiments, predetermined protocols may be established for photographing specific items (e.g., each of a top, bottom, and perspective photos for a couch or other item, or both), and the images taken or published to the aforementioned web pages may adhere to those protocols.

The photos may be uploaded to a computer, and may be accessible to the customer and the mover (e.g., uploaded to a third-party database and made accessible via a web server associated with the third party). The photos may be made accessible, for example, to users of computers (e.g., desktop computers, cell phones with web browsers installed thereon, other computing devices) who have received a password or login ID, or both. In the event of a claim, the customer may be able to submit photographic documentation of the damage (e.g., via the physical mail or electronically, or both, such as by uploading the photos to a database over a network), which can be compared to the mover's ‘before and after’ documentation.

In various embodiments, advantageously this will eliminate or greatly reduce the following:
1. misinterpretation of subjective data on inventory sheets; and
2. need for distinguishing between pre-existing damage and ‘transit-related’ damages.

In various embodiments, this process will increase the following:
1. expedition of claim handling or settling; and
2. training crew and protecting furniture, as specific data for damages now can be easily tracked.

In some embodiments, the aforementioned web pages or other digital inventory pages may be provided for the movers to use on the day of the pick-up. In this manner, the movers may be provided with a digital record of each item, so that if they notice any new damages, the new damages can still be notated prior to shipping. This may alleviate any concern on the part of the mover that the condition of what was digitally inventoried (e.g., 1-3 days prior to loading) is the same as the condition of the items on the day of the move. As known to those skilled in the art, a lot can happen 1-3 days prior to a move (children, pets, in-laws, contractors, can damage items at any time, so additional damage can and often will occur between the time that the items are digitally inventoried, and the time that the movers show up for the move). Notations regarding new damages to previously digitally inventoried items may be made manually by a mover writing on an inventory sheet (e.g., and then later entered into electronic form for inclusion on the web pages), entered electronically into a suitable computing device on-site (e.g., for real-time communication with the web server responsible for publishing the web pages), or according to any other suitable approach.

Alternatively or additionally, the pages may serve as a checklist for the movers, so that the items accounted for in the price of the move are the items that are actually moved. Alternatively, if there are any changes (e.g., the dining room set is being moved for the customer, but the sofa and love seat will now stay with the customer's spouse as part of the divorce), they can be accounted for accordingly in the price. This should alleviate a point of contention often encountered in the moving industry, as customers typically change their minds on what they are keeping or moving, yet are often unforgiving when the price changes.

In some embodiments, the system and methods of the present invention may be implemented using software. The software system may include a database (e.g. a database server) used to store the digital photographs of the customer's items to be shipped by the mover. When the mover takes a complete inventory of all of the items to be shipped, he may transfer the digital photographs from his camera to the database. The software system, interacting with the database, may be enabled to create records in the database for the customer and the customer's items. The database records may include customer identification data, and include one or more or preferably all of: the customer's name, phone number, list of items to be shipped, corresponding photographs of the items to be shipped, descriptions of the items to be shipped, and destination address, and the like. A user interface of the system may include the ability to modify records in the database. For example, a customer's phone number may change between the time that the records were created to the time of the actual move and the moving company may need to update the customer's record. In addition, the user interface may be used by the customer to submit claims subsequent to a move. The claims processor (e.g. a third party) may use the user interface to accept or deny a claim once it has been submitted by a customer. Finally, the system may include an application to receive inventory from the mover and to receive and process claims of the customer. This application may interact with database to create queries of records to be retrieved for a customer. The application may then send the results of the queries to the user interface for display to a customer, for example. Alternatively or additionally, the application may process accepted and denied claims and send claims checks when required. The application may communicate with the web server to keep web pages up-to-date, or the application may run as a web server.

Thus it is seen that methods and systems are provided for inventorying shipments of items and processing claims for damages. Although particular embodiments have been disclosed herein in detail, this has been done by way of example for purposes of illustration only, and is not intended to be limiting with respect to the scope of the appended claims, which follow. In particular, it is contemplated by the inventors that various substitutions, alterations, and modifications may be made without departing from the spirit and scope of the invention as defined by the claims. Other aspects, advantages, and modifications are considered to be within the scope of the following claims. The claims presented are representative of the inventions disclosed herein. Other unclaimed inventions are also contemplated. Applicant reserves the right to pursue such inventions in later claims.

Insofar as embodiments of the invention described above are implementable, at least in part using a computer system, it will be appreciated that a computer program for implementing at least part of the described methods or the described systems is envisaged as an aspect of the present invention. The computer system may be any suitable apparatus, system or device, electronic, optical or a combination thereof. For example, the computer system may be a programmable data processing apparatus, a general purpose computer, a Digital Signal Processor, an optical computer or a microprocessor. The computer program may be embodied as source code and undergo compilation for implementation on a computer, or may be embodied as object code, for example.

It is also conceivable that some or all of the functionality ascribed to the computer program or software system aforementioned may be implemented in hardware, for example by means of one or more application specific integrated circuits or optical elements. Suitably, the computer program can be stored on a carrier medium in computer usable form, which is also envisaged as an aspect of the present invention. For example, the carrier medium may be solid-state memory, optical or magneto-optical memory such as a readable and/or writable disk for example a compact disk (CD) or a digital versatile disk (DVD), or magnetic memory such as disk or tape, and the computer system can utilize the program to configure it for operation. The computer program may also be supplied from a remote source embodied in a carrier medium such as an electronic signal, including a radio frequency carrier wave or an optical carrier wave.

The foregoing description is intended to illustrate but not to limit the scope, which is defined by the scope of the appended claims. Other embodiments are within the scope of the following claims.

What is claimed is:

1. A method for inventorying a shipment of an item electronically and for processing claims alleging damage to the item, the method comprising:
i. generating a first digital document for a surface area of the item belonging to a customer prior to handling;
ii. storing the first document produced;
iii. shipping the item;
iv. generating a second digital document of the surface area of the item belonging to the customer after handling;
v. storing the second document produced;
vi. receiving a claim alleging damage to the item as a result of the shipment; and
vii. accepting or denying the claim based at least in part on a comparison of the claim to at least one of the first document and the second document.

2. The method of claim 1, wherein storing the first document further comprises storing a textual description of a condition of the item before the shipment.

3. The method of claim 1, wherein storing of the at least one of the first document and the second document comprises uploading the document to a computer memory.

4. The method of claim 1, wherein storing the at least one of the first document and the second document comprises uploading the document to a database.

5. The method of claim 1, wherein receiving a claim comprises receiving a third digital document that depicts the item after the shipment.

6. The method of claim 1, wherein receiving a claim comprises receiving a textual description of a condition of the item after the shipment.

7. The method of claim 1, wherein the at least one of the first document and the second document is a video recording.

8. The method of claim 1, wherein the at least one of the first document and the second document is a photograph.

9. A system for inventorying a shipment of an item electronically and for processing claims for damage to the item, the system comprising:
a database for storing at least one video or photograph of the item belonging to a customer, wherein the at least one video or photograph depicts the item prior to shipment; and,
at least one server for receiving a claim alleging damage to the item as a result of the shipment and for publishing the claim to a web page.

10. The system of claim 9, the claim comprises at least one video or photograph that depicts the item after shipment.

11. The system of claim 10, wherein the photograph is digital.

12. The system of claim 10, wherein the video is digital.

13. The system of claim 10, wherein the claim further comprises a textual description of a condition of the item before the shipment.

14. The system of claim 13, wherein the textual description is electronic.

15. The system of claim 10, wherein the claim further comprises a textual description of a condition of the at least one item after the shipment.

16. The system of claim 15, wherein the textual description is electronic.

17. The system of claim 10, wherein the at least one video or photograph depicts a complete surface area of the item.

18. A software system for inventorying items and processing damage claims to items for shipment, said system comprising:
a database adopted to store at least one digital video or photograph of said items and said claims, wherein records of customers are comprised of said at least one video or photograph;
a user interface adopted to edit descriptions of said items, add at least one video or photograph of said items, and submit said claims; and
an application adopted to receive said inventory and process said claims, wherein said application can connect to said database to create and access said records.
